(19) United States
(12) Patent Application Publication
(10) Pub. No.: US 2025/0073986 A1
(43) Pub. Date: Mar. 6, 2025

(54) METHOD FOR PRODUCING A TEXTILE COMPONENT

(71) Applicant: ON CLOUDS GMBH, CH-8005 ZÜRICH (CH)

(72) Inventors: Johannes VOELCHERT, Zürich (CH); Elias Miguel ORTIZ, Zürich (CH); Anna-Maria GEORGARAKIS, Zürich (CH)

(73) Assignee: ON CLOUDS GMBH, CH-8005 ZÜRICH (CH)

(21) Appl. No.: 18/816,385

(22) Filed: Aug. 27, 2024

(30) Foreign Application Priority Data
Aug. 31, 2023 (CH) 000931/2023

(51) Int. Cl. B29C 64/118; B29C 64/209; B29C 64/245; B29C 64/30; B29K 101/12; B29L 31/50; B33Y 10/00; B33Y 80/00

(52) U.S. Cl. CPC B29C 64/118; B29C 64/209; B29C 64/245; B29C 64/30; B33Y 10/00; B33Y 80/00; B29K 2101/12; B29K 2995/0097; B29L 2031/505

(57) ABSTRACT

A method for producing a textile element (1), in particular a shoe upper, including at least the steps of providing a shaping carrier (2), in particular a last; providing a thermoplastic filament (3), in form of a continuous thermoplastic filament; applying the thermoplastic filament (3) on the shaping carrier (2) such that it forms a plurality of loops (4) on the shaping carrier (2) and fusing the applied thermoplastic filament (3) into one fabric. An article of apparel, in particular a shoe, including the textile element, in particular a shoe upper, may be produced by the method.

### CROSS-REFERENCE TO RELATED APPLICATIONS

Swiss Patent Application Nos. CH 000931/2023, filed 31 Aug. 2023, the priority document, corresponding to this invention, to which a foreign priority benefit is claimed under Title 35, United States Code, Section 119, and its entire teachings are incorporated, by reference, into this specification.

### FIELD OF THE DISCLOSURE

The present disclosure relates to the field of producing a textile element, in particular a shoe upper, and relates to a method for producing such a textile element as well as a textile element produced with this method.

### BACKGROUND OF THE DISCLOSURE

Different methods for producing textile elements are known in the prior art. In particular, shoe uppers are typically made from traditionally produced textile elements. Traditionally, textile shoe uppers are for example knitted and then joined to a sole. In known processes, the properties of the knitted textile element may be influenced by the choice made regarding the knitting technique or lapping. In addition, solid shoe uppers, used for example in hard shell shoes, such as ski boots, ice skating boots etc. are typically made in a casting process, e.g. by injection molding, or also by additive manufacturing, respectively 3D printing. The advantage of 3D-printed shoe uppers consists in that the shoe uppers can be adapted individually to the particularities of the runner's foot, in particular the contour of the foot.

### SUMMARY OF THE DISCLOSURE

While textiles are often associated with woven fabrics, weaving is not the only manufacturing method. Knitting and non-woven are other popular types of fabric manufacturing. In the contemporary world, textiles satisfy the material needs for versatile applications, from simple daily clothing to bulletproof jackets, spacesuits, etc.

Compared with traditional textile engineering production methods, additive manufacturing of the textile element has the advantage that sections of the textile can be constructed differently without significantly greater efforts. For example, a fiber produced by 3D printing may have a larger diameter in some regions than in others, e.g., to strengthen certain areas selectively. In contrast, it is not readily possible in traditional production to use a yarn which has a greater diameter in the desired regions of the textile than in other regions. Moreover, with additive manufacturing it is possible to recreate different lapping patterns and mesh widths. Thus, for example, one sub region of a textile may be configured as a knit, while another sub region is configured as a woven. This is practically not possible with traditional textile production methods. Furthermore, traditional textile production methods are normally associated with significant amounts of cuttings, which is detrimental to the sustainability of such methods.

For shoes with soft textile shoe uppers, in particular those made from fibrous materials, as they are typically used in sports shoes, e.g. running shoes, and everyday shoes, additive manufacturing nevertheless continues to present several problems. This is mainly because additive production of knitted or woven items often results in the printed fibers being stuck together, and consequently it is not possible to obtain the same properties, particularly in terms of flexibility, as in the traditional textile engineering production methods such as knitting or weaving. Therefore, 3D printing is not suitable for producing flexible and lightweight textile elements. In addition, 3D printing is rather a slow process and therefore not cost-efficient for mass production.

As an alternative to 3D printing, particularly the FDM method or the melt blown process is known and used to produce textile elements. However, only nonwovens can be manufactured with the melt blown process, it is typically not possible to produce enduring and regularly formed, particularly mesh-like or loop-like textile elements with the melt blown process.

The general objective of the present disclosure is therefore to advance the state of the art in the field of textile element production and preferably to overcome the disadvantages of the prior art fully or partly. In advantageous embodiments a method is provided which allows the creation of a mesh like textile element with various different mesh geometries. In further advantageous embodiments, an enduring textile element can be provided, which preferably shows a high tear and wear resistance.

The present disclosure relates to a method for producing a textile element, in particular a shoe upper. The method comprises at least the following steps:
providing a shaping carrier, in particular a last;
providing a thermoplastic filament, preferably in form of a continuous thermoplastic filament;
applying, preferably laying the thermoplastic filament on the shaping carrier such that the thermoplastic filament forms a plurality of loops on the shaping carrier;
fusing the applied thermoplastic filament into the textile element, preferably a fabric.

It is understood herein that the references a), b), c), etc. of the steps do not imply a specific order of steps. Although it may in some embodiments be the case that steps a) is performed before step b) and step b) is performed before step c) it may also be the case that for example steps a) and b) are performed at the same time or that step b) is performed before step a). These references merely serve to identify and reference specific steps.

A textile element may for example be a fabric. A textile element may include various fiber-based elements, including fibers, yarns, filaments, threads or also different fabric types. A textile element in the sense of the present disclosure may be created by laying webs of thermoplastic filament forming loops. The webs can be, depending on the design or mechanical properties needed, laid essentially parallel next to each other and/or overlapping and/or or crossing. A loop in the sense of the present disclosure is to be understood in a broad sense. Besides essentially rounded loops, such as circular loops, also oval shaped, snake lines or zigzag patterns are possible. However, the loops are preferably rounded loops. The thermoplastic filament can be applied in form of a continuous filament, which is stored on e.g. a bobbin.

In step c. the thermoplastic filament may in some embodiments be applied such that the formed loops partially overlap with each. The thermoplastic filament may thereby form crossings with itself. In the case of a solid filament, the overlapping loops can be laid in a scale pattern. The thermoplastic filament may be applied directly and/or also indirectly to the shaping carrier. The application may be considered as indirect when a plurality of layers of the filament, are applied. In this case, it is possible that only a first layer of filament is in direct contact with the shaping carrier.

To form a continuous textile, the fusing in step d can be carried out, such that the loops are materially bonded with each other at the crossings. By melting or at least softening the thermoplastic filament, the overlapping sections of the thermoplastic filament can be joined together in form of a material bond. Depending on the chosen parameters, in particular

RP-509 3 KDE temperature and process time, a material bond can be achieved in particular only at the crossings. The fusing in step d. may be carried out by heating up the shaping carrier and/or by softening, in particular melting, the thermoplastic filament, preferably by hot air or infrared radiation, which is applied onto the applied thermoplastic filament. It is understood that the thermoplastic filament is in such embodiments typically heated at least to a softening temperature, in particular up to the melting temperature of the thermoplastic filament.

For producing the textile element in the sense of the present disclosure a shaping carrier is provided. The shaping carrier can be any physical object, as the textile element according to the present disclosure is not restricted to any geometrical constraints. The shaping carrier can be also in form of a carrier material, e.g. a carrier film or a carrier textile. The shaping carrier can therefore have a two-dimensionally or three-dimensionally shaped application surface on which the thermoplastic filament is applied. In the context of producing a shoe upper, the shaping carrier may for example be a last for a shoe with a three-dimensionally shaped application surface. Alternatively, a flat upper may be provided on a planar carrier. After its production such an upper may be shaped on a last and connected to sole for providing a shoe.

The last can be a conventional shoe last, made of a polymer composition, metal, wood or the like, as will be described in more detail below noted. In some embodiments, the shaping carrier may include heating or cooling elements, respectively it is heatable or coolable. The advantage of this is that the thermoplastic filament and/or the textile element produced can be materially bonded, in particular welded, directly to another element. For example, in some embodiments at least sub-regions of the shaping carrier may be heated after the application of the thermoplastic filament to the shaping carrier for fusing the thermoplastic filament at the crossings and optionally after the textile element has cooled and hardened, in such manner that an additional component may be welded to the textile element. In the context of shoe production, an insole or a midsole may be welded directly to the shoe upper made of the textile element.

In some embodiments the textile element is typically made from a thermoplastic filament comprising, in particular consisting of, a polyamide, polyether block amide, polyurethane and/or polyester or a combination thereof. Alternatively, or in addition, also an at least partially biodegradable polymer or polymer composition is possible as well.

In some embodiments, the thermoplastic filament has a filament thickness in the range of 0.01 mm to 0.3 mm, in particular from 0.05 mm to 0.2 mm. Such filament diameters are advantageous as they result in a sufficiently flexible bit also stable filament. To ensure that the thermoplastic filament which has been applied, preferably laid on the shaping carrier in form of a plurality of loops remains in position, the shaping carrier may comprise a three-dimensional pattern formed by protrusions. The laid filament clasps, respectively hitches to the protrusions and is thereby secured in place. The protrusions may be in particular pins, for receiving the applied thermoplastic filament during step c and securing it in place until step d. is carried out. The three-dimensional pattern can be e.g. in form of a grid for maintaining the loops after the application until the fusion in step d. has been carried out. Depending on the field of application, the shaping carrier may be essentially a planar board with protrusions for producing a flat textile element.

The thermoplastic filament may be applied by winding it about the protrusions. This can be done for example by a robotic arm or a CNC machine, thereby forming the loops. The robotic arm or a CNC machine may in some embodiments be programmed to place the thermoplastic filament in form of loops by handling means onto the shaping carrier by following a programmed travel path. Alternatively, or in addition, the thermoplastic filament may during step c. be applied through at least one nozzle, preferably by a pressurized medium, onto the shaping carrier. To be able to apply the thermoplastic filament in a controlled manner, a depositing unit may be provided. In some embodiments, the depositing unit may comprise a dosing head which comprises the at least one nozzle. The thermoplastic filament can be applied via an outlet of the at least one nozzle, e.g. by blowing the thermoplastic filament out of the nozzle in a solid state or in a molten state. If the thermoplastic filament is applied in a molten state, a plasticizing unit may be provided to plasticize the thermoplastic material.

The thermoplastic filament can also exit the at least one nozzle in a molten state and be applied onto the shaping carrier in a solidified state. To allow the thermoplastic filament to solidify on its flightpath between the at least one nozzle and the shaping carrier, the distance between the at least one nozzle and the shaping carrier may be chosen such that the thermoplastic filament cools below its softening temperature and/or its melting temperature before it comes into contact with the shaping carrier. The distance between the at least one nozzle and the shaping carrier may for example be between 20 mm and 110 mm, in particular between 40 mm to 60 mm.

In some embodiments the thermoplastic filament can exit the at least one nozzle through an outlet and during the application the at least one nozzle is moved relative to, in particular rotated around, a dispensing axis such that the thermoplastic filament forms loops. Due to the movement of the nozzle relative to a dosing head or the movement of the dosing head relative to a dosing head holder, the filament is accelerated on its flight path between outlet and shaping carrier. To create a textile element on the shaping carrier, when applying the thermoplastic filament, the depositing unit and/or the shaping carrier can in a first movement be moved relative to each other such that the at least one nozzle moves along a drive path which runs on the shaping carrier. The drive path defines the pattern and structure of the textile element. During forming each loop, the dosing head and/or the at least one nozzle may additionally be moved in a second movement being different from the first movement along a loop depositing path with a path length such that the length of each loop formed on the carrier is larger than the path length of the depositing path.

The resulting loops can be either round, preferably circular or oval, or have a regular wave-shape, like a sinusoidal shape. The length of each loop formed on the carrier is to be understood as the length of one loop, e.g. in case of a round loop, the length starting from a crossing along the loop up to this crossing, or for example for a circular loop the length of one circle, in case of a sinusoidal loop the length of one period. Due to the acceleration of the filament on its flight path between at least one nozzle and shaping carrier, the filament is radially deflected which causes the enlarged length of each loop formed on the carrier in relation to the path length of the loop depositing path.

The depositing path is typically different from the drive path, in particular wherein a path length of the drive path along which the at least one nozzle moves during the formation of each loop is shorter than the path length of the depositing path during formation of each loop. Usually, the first movement and the second movement are superimposed. The second movement may comprise moving the at least one nozzle relative to the dosing head. The thermoplastic filament typically exits the at least one nozzle through an outlet, typically in form of an opening, forming the filament. During the application the at least one nozzle may be moved relative to the dispensing axis, preferably rotated around the dispensing axis, such that the filament forms loops. In some embodiments the nozzle may extend along an outlet axis, which is aligned at an inclined angle with respect to the dispensing axis. In some embodiments, during the application the shaping carrier is spaced a distance D apart from the at least one nozzle and the shape of the formed loops corresponds to a movement pattern of the at least one nozzle in an enlarged scale.

Alternatively, or in addition, the at least one nozzle may comprise an outlet opening and a plurality of air exit openings arranged around the outlet opening, from which a pressurized medium, e.g. a gas or pressurized air, impinges on the thermoplastic filament, such that the thermoplastic filament which has exited the outlet opening is applied to the shaping carrier forming loops. The thermoplastic filament may in certain embodiments be applied to the shaping carrier by means of a nozzle, which comprises an outlet opening for the thermoplastic filament and a plurality of air exit openings arranged around the outlet opening, from which compressed air impinges on the exiting thermoplastic filament such that the thermoplastic filament which has exited the nozzle is applied to the shaping carrier as a helical filament. This means that the filament is at least between the outlet opening and the carrier in the form of a helical filament, or is in the form of a helical filament at least in a sub-region between the outlet opening and the carrier.

As a consequence, a loop-like textile element comprising the thermoplastic filament forms on the shaping carrier. In this context, a loop-like textile element may comprise a plurality of intersecting, but preferably not entangling, coils or loops. Compared with a non-woven, the shoe upper therefore has one or more regularly arranged filaments. By preselecting the characteristics of the helix, in particular the pitch, the lead, the lead angle and the radius of the helix, the properties of the produced textile element may then be varied and adjusted selectively and at any predefined point in time. For example, a very small radius creates a region in the textile element with very tight loops or coils, and consequently to lower elasticity and higher stability, such as is needed for example in areas that are exposed to high mechanical loads. Selection of a larger radius of the helical filament creates a region in the textile element with larger loops or coils, which results in greater elasticity in this region. The helical filament may have a constant or varying radius in the direction of the shaping carrier. In particular, the radius of the helix may increase from the outlet opening towards the shaping carrier, preferably constantly.

Alternatively, the thermoplastic filament can be stitched with a thermoplastic stitching filament to a carrier material. For example, this may be performed by tailored fiber placement (TFP). TFP is a textile manufacturing technique based on the principle of sewing for a continuous placement of fibrous material. The fibrous material is typically fixed with an upper and lower stitching thread on a base material. The stitching thread is preferably also made from a thermoplastic material. In particular, the stitching thread may have a melting temperature and/or softening temperature which is equal or lower than the melting temperature and/or softening temperature of the thermoplastic filament. The machinery is based on embroidery machinery used in the garment textile industry. TFP allows to produce preforms, which are produced continuously by the placement of a single filament. The filament is typically pulled off a spool and is guided by a pipe which is positioned in front of the stitching needle. The carrier material cam be moved synchronized stepwise to perform the stitching relative to the needle position. During each stitch the stitching filament is pulled through the carrier material and looped around the thermoplastic filament. Hence, typically a double backstitch is performed. The stitching path can be designed in form of a pattern either with the help of classical design embroidery software or more recently by use of 2D-CAD systems. Afterwards necessary information of the stitch positions are added to the pattern with the help of so-called punch software and finally transferred to the TFP machine.

Compared with a non-woven, the shoe upper therefore has preferably one or more regularly arranged filaments. If the at least one nozzle is moved relative to the dispensing axis, the thermoplastic filament exits the at least one nozzle and is, caused by the relative movement of the at least one nozzle, along the flight path between the at least one nozzle and shaping carrier accelerated. When the at least one nozzle revolves on a circular path around the dispensing axis, the resulting centrifugal force accelerates the filament radially away from the circular path of the at least one nozzle. The depositing unit may comprise a dosing head holder to which the dosing head is connected and wherein the second movement comprises moving the dosing head and the at least one nozzle together relative to the dosing head holder. The thermoplastic filament can exit the at least one nozzle through the outlet forming the filament and during the application the dosing head and the at least one nozzle are together moved relative to the dosing head holder about the dispensing axis such that the filament forms loops.

The at least one nozzle may be tilted with respect to the dosing head about an angle. In some embodiments, the angle between the dispensing axis and the outlet and the discharge direction is between 40° and 60°, preferably between 50° and 60°, in particular 55°. The at least one nozzle may be dynamically is pivoted about an axis with respect to the dispensing axis. In addition, the shaping carrier can be moved along at least one degree of freedom about an axis. This movement allows to create loops with a more complex geometry. For example, loops essentially shaped like the infinity symbol are possible with a tumbling nozzle.

The textile element is a shoe upper and is after its production bonded to a sole, or the shoe upper is bonded directly to a sole during fusing of step d. For the production of a shoe upper or even an entire shoe, the shaping carrier may be a last is previously stated.

The last may be produced in a first step on the basis of a 3D model of the wearer's foot. For this, a wearer's foot may be measured, and a 3D model thereof created on the basis thereof. This results in the production of an individual shoe upper adapted to the foot of the runner. In alternative embodiments, the shaping carrier may be a model of a textile product, like a bag, a backpack, etc. The shaping carrier may also be a plate for producing an essentially two-dimensional textile product.

The shaping carrier may in some embodiments be heatable such that the textile element produced can be materially bonded, in particular welded, directly to another element. The shaping carrier may in some embodiments be coolable to reduce the cycle time by fastening the demolding process. In some embodiments at least subregions of the carrier may be heated after the application of the thermoplastic filament to the heatable shaping carrier, and optionally after the applied thermoplastic filament has cooled and hardened, in such manner that an insole or a midsole may be welded directly to the shoe upper. The fabricated textile element is a shoe upper and is bonded to a sole, or wherein the shoe upper is bonded directly to a sole during application.

An advantage of the present method is to be able to produce a textile element, particularly a shoe upper, within a much shorter process time. The shaping carrier can be moved relative to the dosing head and the at least one nozzle at a speed of 1 m/min to 20 m/min, in particular 5 m/min to 15 m/min. For example, in this way it is possible to produce an entire shoe upper in only 1 minute to 3 minutes, typically in about 1.5 minutes. Amongst others, because of this very short process time, it is therefore possible to significantly reduce the energy consumption per unit of textile element produced, in particular per shoe upper. In particular, just 0.035 to 0.06 kWh is required to produce a shoe upper. For the purpose of the present disclosure, a shoe upper refers to a shoe upper which is configured as a textile, and is therefore of softer, more flexible construction as compared to a hard shell shoe upper.

In some embodiments, the shaping carrier, in particular the last, may include, respectively define, one or more depressions, in particular grooves. In this way, it may be possible for additional elements such as textile element, foam material, cushioning material, metal or plastic material to be inserted into the depressions before the thermoplastic filament is applied to the shaping carrier. When the thermoplastic filament is applied, a material bond is created between the thermoplastic filament and the additional elements. For example, the shaping carrier may be a last, which has one or more depressions in the heel region. An impact-absorbing material may be dispensed in these depressions, and arranged in such manner that the heel region of the shoe upper is configured to absorb impacts, or that a heel cushion (also called “heel padding”) is formed.

An article of apparel, in particular a shoe, comprising a textile element, in particular a shoe upper, produced by a method according to the present disclosure. It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims.

FIG. 1 shows a schematic illustration of a variation of the shaping carrier with protrusions and wound thermoplastic filament being fused;

FIG. 2 shows a schematic illustration of a first variation of the method for producing a textile element, being carried out by winding the thermoplastic filament with a robotic arm;

FIG. 3 shows a schematic illustration of a second variation of the method for producing a textile element, being carried out by applying the thermoplastic filament through a nozzle onto the shaping carrier;

FIG. 4 shows a schematic illustration of a third variation of the method for producing a textile element, being carried out by applying the thermoplastic filament through a rotating nozzle;

FIG. 5 shows a schematic illustration of a fourth variation of the method for producing a textile element, being carried out by applying the thermoplastic filament through a nozzle which is moved in an oscillating manner;

FIG. 6 shows a schematic illustration of a fifth variation of the method for producing a textile element, being carried out by applying the thermoplastic filament through a nozzle which is moved by an eccentric drive;

FIG. 7 shows a schematic illustration of a sixth variation of the method for producing a textile element, being carried out by stitching the thermoplastic filament on a carrier material; and

FIG. 8 shows a schematic illustration of a variation of the fused thermoplastic filament with fused crossings.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts. In the shown illustrations, the ratios of the shown components are to each other not true to scale. This was done in order to allow a better presentation, so no conclusions can be drawn about the actual sizes.

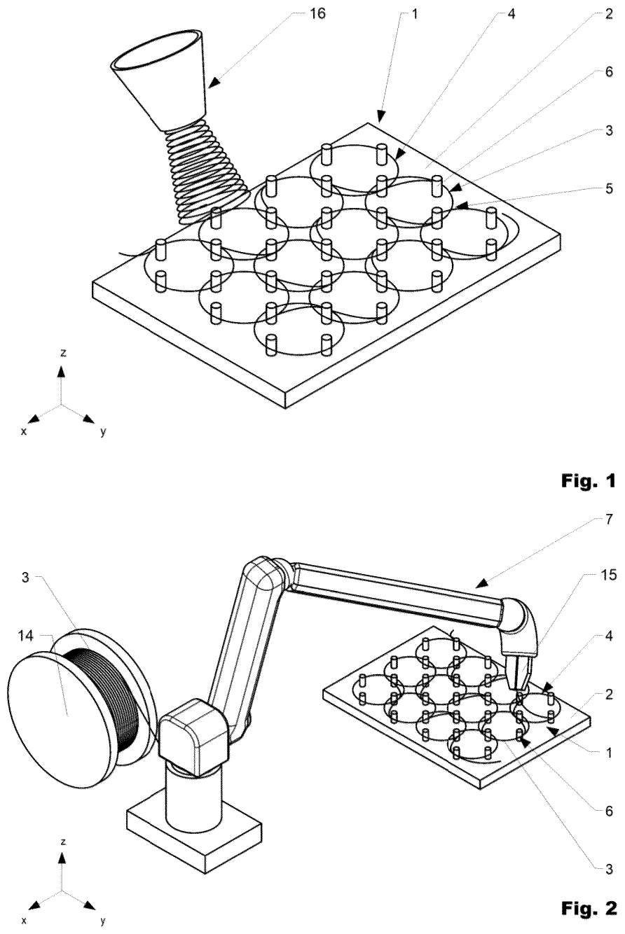

FIG. 1 shows a schematic illustration of a variation of the shaping carrier 2 with protrusions 6 and thermoplastic filament 3 being wound about the protrusions 6. The shown textile element 1 is produced by laying webs of thermoplastic filament 3 forming loops 4. The webs are, depending on the design or mechanical properties needed, laid essentially parallel next to each other, or like in the shown variation laid overlapping and crossing. The shown loops 4 are essentially circular, the loops 4 can alternatively also be oval shaped, in form of snake lines or zigzag patterns. The shown thermoplastic filament 3 is applied in form of a continuous filament 3, which is stored on e.g. a spool. The thermoplastic filament 3 is applied, such that the formed loops 4 partially overlap and thereby form crossings 5. The shown loops 4 formed by the solid filament 3 are laid in a scale pattern. To form a continuous textile element 1, the laid filament 3 is fused in a subsequent step, such that the loops 4 are materially bonded with each other at the crossings 5. In the shown variation, the thermoplastic filament 3 is molten. The overlapping sections of the thermoplastic filament 3 at the crossings thereby join together and form of a material bond. The fusing can be carried out by heating up the shaping carrier 2 and/or by softening, in particular melting, the thermoplastic filament 3. In the shown variation, the thermoplastic filament 3 is molten by hot air which is applied onto the applied thermoplastic filament by the heating nozzle 16.

FIG. 2 shows a schematic illustration of a first variation of the method for producing a textile element 1, being carried out by winding the thermoplastic filament 3, stored on a spool 14, with a robotic arm 7. The shown robotic arm 7 or alternatively a CNC machine is programmed to place the thermoplastic filament 3 in form of loops 4 by handling means 15 onto the shaping carrier 2 by following a programmed travel path. To ensure that the thermoplastic filament 3 which has been applied on the shaping carrier 2 in form of a plurality of loops 4 remains in position, the shown shaping carrier 2 comprises a three-dimensional pattern. The three-dimensional pattern in form of a grid is formed by protrusions 6 in form of pins, for receiving the applied thermoplastic filament 3 as shown. The thermoplastic filament 3 is secured by the protrusions 6 in place until the filament 3 is fused in a subsequent step. In the shown variation, the shaping carrier 2 is an essentially planar board with protrusions 6 for producing the flat textile element 1.

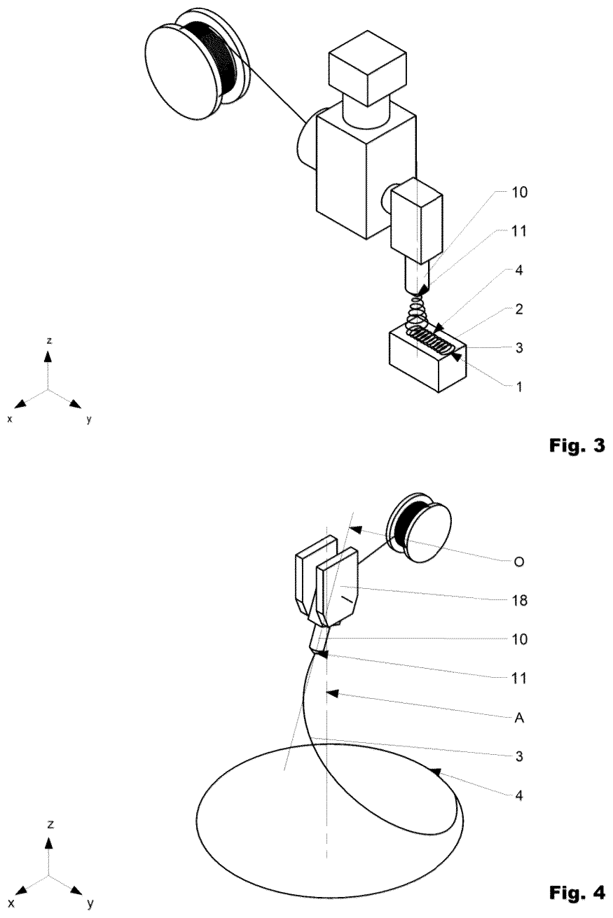

FIG. 3 shows a schematic illustration of a second variation of the method for producing the textile element 1. The method is carried out by applying the thermoplastic filament 3 through a nozzle 10 onto the shaping carrier 2. The thermoplastic filament 3 exits the at least one nozzle 10 in a molten state and is applied onto the shaping carrier 2 in a solidified state. To allow the thermoplastic filament 3 to solidify on its flightpath between the at least one nozzle 10 and the shaping carrier 2, the distance between the at least one nozzle 10 and the shaping carrier 2 must be chosen such that the material has enough time to solidify. The distance between the at least one nozzle 10 and the shaping carrier 2 is typically between 20 mm and 110 mm, in particular between 40 mm to 60 mm. Alternatively, or in addition, the at least one nozzle 10 may comprise an outlet 11 in form of an opening and a plurality of air exit openings arranged around the outlet, from which a pressurized medium impinges on the thermoplastic filament 3, such that the thermoplastic filament 3, which has exited the outlet opening 11, is applied to the shaping carrier 2 by forming loops 4 on its flight path. This means that the filament 3 is at least between the outlet 11 and the shaping carrier 2 in the form of a helical filament, or is in the form of a helical filament at least in a subregion between the outlet 11 and the shaping carrier 2. By preselecting the characteristics of the helix, in particular the pitch, the lead, the lead angle and the radius of the helix, the properties of the produced textile element 1 are varied and adjusted selectively and at any predefined point in time. For example, a very small radius creates a region in the textile element 1 with very tight loops or coils, and consequently to lower the elasticity and higher stability, such as is needed for example in areas that are exposed to high mechanical loads. Selection of a larger radius of the helical filament creates a region in the textile element 1 with larger loops or coils, which results in greater elasticity in this region. The helical filament 3 may have a constant or varying radius in the direction of the shaping carrier 2. In particular, the radius of the helix may increase from the outlet 11 towards the shaping carrier 2, preferably constantly.

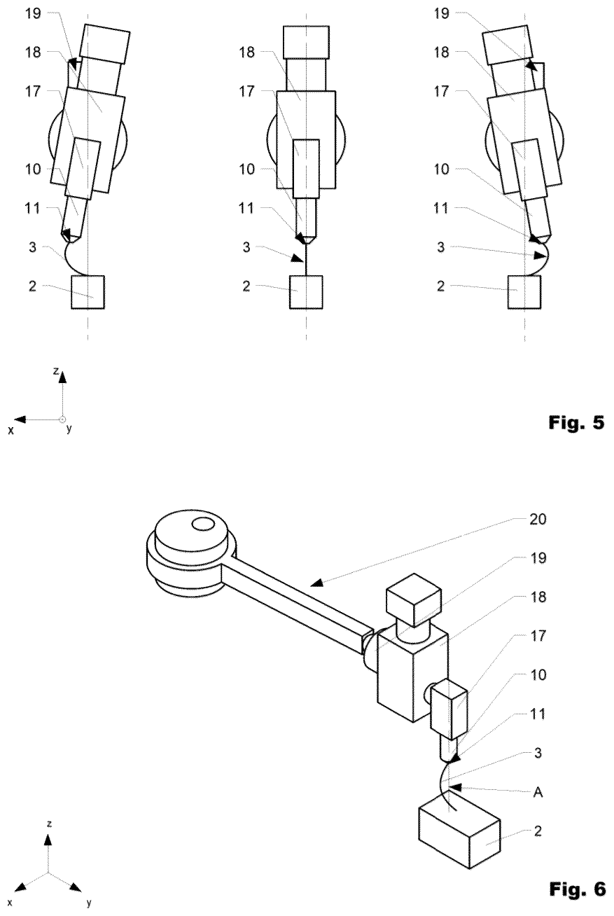

FIGS. 4 to 6 show schematic illustrations of variations of the method for producing a textile element 1, being carried out by applying the thermoplastic filament 3 through a moving nozzle 10. The shown methods are carried out by a depositing unit and a relative movement of the nozzle 10 to create the loops 4. The depositing unit can comprise a dosing head 18 and a dosing head holder. As shown for example by FIG. 4, the dosing head 18 and thereto arranged nozzle 10 are moved relative to the dosing head holder 18 in a rotational manner. As shown by FIGS. 5 and 6, the filament 3 is accelerated on its flight path between outlet 11 and shaping carrier 2 by an oscillating movement. To create a textile element I on the shaping carrier 2, when applying the thermoplastic filament 3, the depositing unit 17 and/or the shaping carrier 2 are in a first movement moved relative to each other such that the at least one nozzle 10 moves along a drive path which runs on the shaping carrier 2. The drive path defines the pattern and structure of the textile element 1. During forming each loop, the dosing head 18 and/or the at least one nozzle 10 are additionally moved in a second movement being different from the first movement along a loop depositing path with a path length, such that the length of each loop formed on the shaping carrier 2 is larger than the path length of the depositing path. The depositing path is typically different from the drive path, in particular wherein a path length of the drive path along which the at least one nozzle 10 moves during the formation of each loop 4 is shorter than the path length of the depositing path during formation of each loop 4. In all shown variations, the first movement and the second movement are superimposed.

FIG. 4 shows a schematic illustration of a third variation of the method for producing a textile element 1, being carried out by applying the thermoplastic filament 3 through a rotating nozzle 10. To create a loop shape, the thermoplastic filament 3 exits the at least one nozzle 10 through an outlet 11 and during the application the at least one nozzle 11 is rotated around, a dispensing axis A such that the thermoplastic filament 3 forms loops 4. The at least one nozzle 10 extends along an outlet axis O, which is aligned at an inclined angle with respect to the dispensing axis A. FIG. 5 shows a schematic illustration of a fourth variation of the method for producing a textile element 1, being carried out by applying the thermoplastic filament 3 through a nozzle 10, which is moved in an oscillating manner. The thermoplastic filament 3 exits the at least one nozzle 10 through an outlet 11, typically in form of an opening. FIG. 6 shows a schematic illustration of a fifth variation of the method for producing a textile element 1, being carried out by applying the thermoplastic filament 3 through a nozzle 10, which is moved by an eccentric 20.

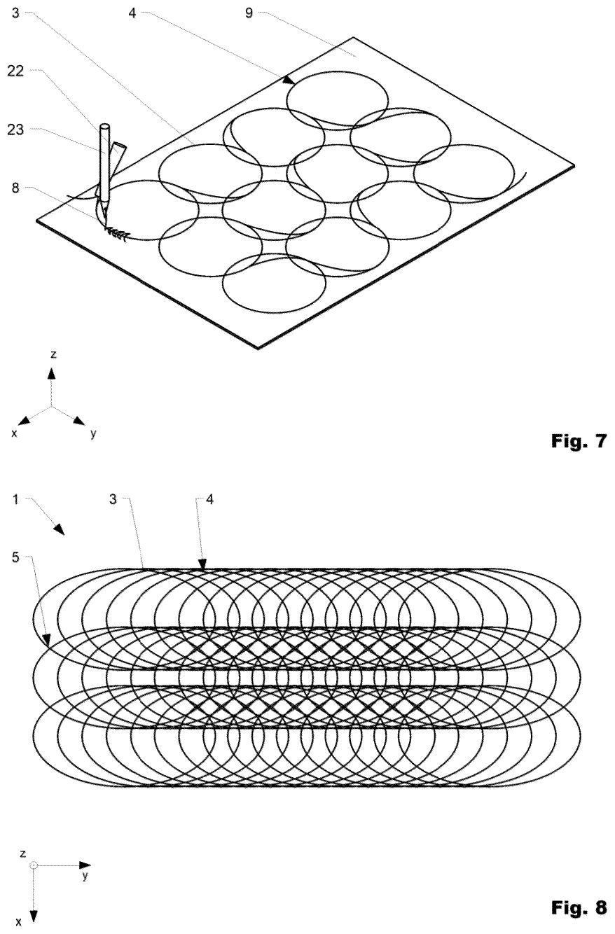

FIG. 7 shows a schematic illustration of a sixth variation of the method for producing a textile element 1, being carried out by stitching the thermoplastic filament 3 on a carrier material 9. The thermoplastic filament is stitched with a thermoplastic stitching filament 8 to a carrier material 9, in the shown variation in form of a textile. The shown method is based on the principle of sewing for a continuous placement of fibrous material. The thermoplastic filament 3 is fixed with a stitching filament 8 by an upper and lower stitching thread on the carrier material 9. The machinery is based on embroidery machinery used in the garment textile industry. TFP allows to produce preforms, which are produced continuously by the placement of a single filament. The thermoplastic filament 8 is pulled off a spool 21 and is guided by a pipe 22 which is positioned in front of the stitching needle 23. The carrier material 9 can in addition be moved synchronized stepwise to perform the stitching relative to the needle position. During each stitch the stitching filament 8 is pulled through the carrier material 9 and looped around the thermoplastic filament 3. In the shown variation, a double backstitch is performed. The stitching path can be designed in form of a pattern either with the help of classical design embroidery software or more recently by use of 2D-CAD systems. Afterwards necessary information of the stitch positions are added to the pattern with the help of so-called punch software and finally transferred to the TFP machine.

FIG. 8 shows a schematic illustration of a variation of the fused thermoplastic filament 3 with fused crossings 5. The textile element 1 is created by laying webs of thermoplastic filament 3 forming loops 4. The webs can be, depending on the design or mechanical properties needed, be laid essentially parallel next to each other, overlapping or crossing. A loop 4 in the sense of the present disclosure is to be understood in a broad sense. Besides essentially circular loops, also oval shaped loops 4 as shown, or snake lines or zigzag patterns are possible. The thermoplastic filament 3 is applied in form of a continuous filament, which is stored on e.g. a spool. In step c. the thermoplastic filament 3 is applied such that the formed loops 4 partially overlap with each other forming crossings 5. In the case of a solid filament, the overlapping loops 4 can be laid in a scale pattern. The thermoplastic filament 3 may be applied directly and/or also indirectly to the shaping carrier. The application may be considered as indirect when a plurality of layers of the filament 3, are applied. In this case, it is possible that only a first layer of filament 3 is in direct contact with the shaping carrier. To form a continuous textile, the fusing in step e is carried out, such that the loops 4 are materially bonded with each other at the crossings 5. By melting the thermoplastic filament 3, the overlapping sections of the thermoplastic filament 3 will join together in form of a material bond. The fusing in step d. may be carried out by heating up the shaping carrier and/or by softening, in particular melting, the thermoplastic filament 3, preferably by hot air or infrared radiation, which is applied onto the applied thermoplastic filament 3.

Rather, the words used in the specification are words of description rather than limitation, and it is understood that various changes may be made without departing from the spirit and scope of the disclosure.

1. A method for producing a textile element (1), comprising the steps:
a. providing a shaping carrier (2);
b. providing a thermoplastic filament (3), preferably in form of a continuous thermoplastic filament;
c. applying, preferably laying the thermoplastic filament (3) on the shaping carrier (2) such that it forms a plurality of loops (4) on the shaping carrier (2);
d. fusing the applied thermoplastic filament (3) into a textile element.

2. The method according to claim 1, wherein the thermoplastic filament (3) is in step c. applied such that the formed loops (4) partially overlap with each other.

3. The method according to claim 1, wherein the thermoplastic filament (3) is in step c. applied such that it forms crossings (5) with itself.

4. The method according to claim 3, wherein fusing in step d. is carried out such that the loops (4) are materially bonded with each other at the crossings (5).

5. The method according to claim 1, wherein fusing in step d. is carried out by one of heating up the shaping carrier (2), softening, and melting the thermoplastic filament (3), by hot air or infrared radiation, which is applied onto the applied thermo-plastic filament (3).

6. The method according to claim 1, wherein the shaping carrier (2) comprises a three-dimensional pattern formed by one of protrusions (6) and pins, for receiving the applied thermoplastic filament (3) during step c and securing it in place until step d. is carried out.

7. The method according to claim 6, wherein the thermoplastic filament (3) is wound about the protrusions (6) by a robotic arm (7) or a CNC machine, thereby forming the loops (4).

8. The method according to claim 6, wherein the thermoplastic filament (3) is stitched with a thermoplastic stitching filament (8) to a carrier material (9).

9. The method according to claim 1, wherein the thermoplastic filament (3) is during step c. applied through at least one nozzle (10), by a pressurized medium, onto the shaping carrier (2).

10. The method according to claim 9, wherein the thermoplastic filament (3) exits the at least one nozzle (10) in a molten state and is applied onto the shaping carrier (2) in a solidified state.

11. The method according to claim 9, wherein during the application the shaping carrier (2) is spaced a distance (D) apart from the at least one nozzle (10) and the shape of the formed loops (4) corresponds to a movement pattern of the at least one nozzle (10) in an enlarged scale.

12. The method according to claim 11, wherein the distance (D) between the at least one nozzle (10) and the shaping carrier (2) is between 20 mm and 110 mm, in particular between 40 mm to 60 mm.

13. The method according to claim 9, wherein the thermoplastic filament (3) exits the at least one nozzle (10) through an outlet (11) and wherein during the application the at least one nozzle (10) is moved relative to a dispensing axis (z) such that the thermoplastic filament forms loops (4).

14. The method according to claim 9, wherein the at least one nozzle (10) comprises an outlet opening (11) and a plurality of air exit openings (12) arranged around the outlet opening (11), from which a pressurized medium impinges on the thermoplastic filament (3), such that the thermoplastic filament (3) which has exited the outlet opening (11) is applied to the shaping carrier (2) forming loops (4).

15. The method according to claim 1, wherein the thermoplastic filament (3) and/or the second thermoplastic filament (13) has a filament thickness in the range of 0.01 mm to 0.3 mm, in particular from 0.05 mm to 0.2 mm.

16. The method according to claim 1, wherein the textile element (1) is a shoe upper and is bonded to a sole, or wherein the shoe upper is bonded directly to a sole during fusing.

17. A shoe comprising the textile element forming a shoe upper, produced by a process according to claim 1.

18. The method according to claim 1 wherein the a textile element (1) comprises a shoe upper and the shaping carrier (2) comprises a last.

19. The method according to claim 13, wherein the at least one nozzle (10) is rotated around a dispensing axis (z) such that the thermoplastic filament forms loops (4).
